(19) United States
(12) Patent Application Publication
(10) Pub. No.: US 2024/0118808 A1
(43) Pub. Date: Apr. 11, 2024

(54) CONNECTION POOL MANAGEMENT WITH STRATEGIC CONNECTION ALLOCATION TO REDUCE MEMORY CONSUMPTION OF STATEMENT POOLS

(71) Applicant: International Business Machines Corporation, Armonk, NY (US)

(72) Inventors: Nathan Jon Rauh, Rochester, MN (US); Alex Seitzinger Motley, Rochester, MN (US); Mark Swatosh, ROCHESTER, MN (US); James Stephens, Palisade, MN (US)

(21) Appl. No.: 18/045,627

(22) Filed: Oct. 11, 2022

(51) Int. Cl. G06F 3/06

(52) U.S. Cl. CPC G06F 3/0613; G06F 3/0653; G06F 3/0673

(57) ABSTRACT

A computer implemented method manages connections in a connection pool. A computer system creates a modified call stack for a connection request in response to receiving the connection request. The modified call stack comprises elements that call prepared statements that are part of an application logic for the connection request. The computer system identifies a group of potential connections from the connections in the connection pool matching the connection request. The group of potential connections is associated with a group of associated modified call stacks that call the prepared statements. The computer system determines a group of weighted match scores for the group of associated modified call stacks from a comparison of the modified call stack with the group of associated modified call stacks. The computer system selects a connection from the group of potential connections based on a highest weighted match score in the group of weighted match scores.

### BACKGROUND

### 1. Field

The disclosure relates generally to an improved computer system and more specifically to managing connection pools that are associated with prepared statement pools.

### 2. Description of the Related Art

With various application servers that host applications or software, connection pools can be used to increase performance in processing requests. For example, Java database connectivity (JBDC) connections and prepared statements can be used to improve performance. A prepared statement is a precompiled query statement that can be executed multiple times. For example, a prepared statement can be a precompiled sequential query language (SQL) statement. With some types of database connections, such as JBDC connections, a prepared statement is tied to a specific connection. As a result, closing that connection invalidates the prepared statements.

This situation results in each connection in a connection pool having its own prepared statement pool containing prepared statements. Thus, the maximum number of prepared statements kept within the resulting pool of pools can reach a number that is equal to the maximum connection pool size multiplied by the maximum statement pool size. Further, if multiple data sources are used, each with the same configuration for maximum connection pool size and maximum statement pool size, then that number is multiplied by the number of data sources. For example, up to 12,600 prepared statements can be pooled for 3 data sources, having the same configuration and a maximum connection pool size of 60 and a maximum statement pool size of 70.

### SUMMARY

According to one illustrative embodiment, a computer implemented method manages connections in a connection pool. A computer system creates a modified call stack for a connection request in response to receiving the connection request. The modified call stack comprises elements that call prepared statements that are part of an application logic for the connection request. The computer system identifies a group of potential connections from the connections in the connection pool that matches the connection request. The group of potential connections is associated with a group of associated modified call stacks that call the prepared statements. The computer system determines a group of weighted match scores for the group of associated modified call stacks from a comparison of the modified call stack with the group of associated modified call stacks. The computer system selects a connection from the group of potential connections based on a highest weighted match score in the group of weighted match scores. According to other illustrative embodiments, a computer system and a computer program product for managing connections in a connection pool are provided.

### BRIEF DESCRIPTION OF THE DRAWINGS

FIG. 1 is a block diagram of a computing environment in which illustrative embodiments can be implemented;

FIG. 2 is a block diagram of a connection environment in accordance with an illustrative embodiment;

FIGS. 3A-3B are a diagram illustrating generation of a modified call stack in accordance with an illustrative embodiment;

FIG. 4 is a diagram illustrating determining a weighted match score between modified call stacks in accordance with an illustrative embodiment;

FIG. 5 is a diagram illustrating determining a weighted match score between modified call stacks in accordance with an illustrative embodiment;

FIG. 6 is a diagram illustrating determining a weighted match score between modified call stacks in accordance with an illustrative embodiment;

FIGS. 7A-7B are a flowchart of a process for managing connections in a connection pool in accordance with an illustrative embodiment;

FIG. 8 is a flowchart of a process for creating a modified call stack in accordance with an illustrative embodiment;

FIG. 9 is a flowchart of a process for determining a weighted match score between a modified call stack and an associated modified call stack in accordance with an illustrative embodiment;

FIG. 10 is a flowchart of a process for monitoring usages of connections in accordance with an illustrative embodiment;

FIG. 11 is a flowchart of a process for determining the exclude list from usage of connection for an associated modified call stack in accordance with an illustrative embodiment;

FIG. 12 is a flowchart of a process for managing connections in a connection pool in accordance with an illustrative embodiment;

FIG. 13 is a flowchart of a process for creating a modified call stack in accordance with an illustrative embodiment;

FIG. 14 is a flowchart of another process for creating a modified call stack is depicted in accordance with an illustrative embodiment;

FIG. 15 is a flowchart of a process for determining a group of weighted match scores in accordance with an illustrative embodiment;

FIG. 16 is a flowchart of a process for excluding a potential connection in accordance with an illustrative embodiment;

FIG. 17 is a flowchart of another process for excluding a potential connection in accordance with an illustrative embodiment;

FIG. 18 is a flowchart of another process for increasing a size of a prepared statement pool in accordance with an illustrative embodiment; and

FIG. 19 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

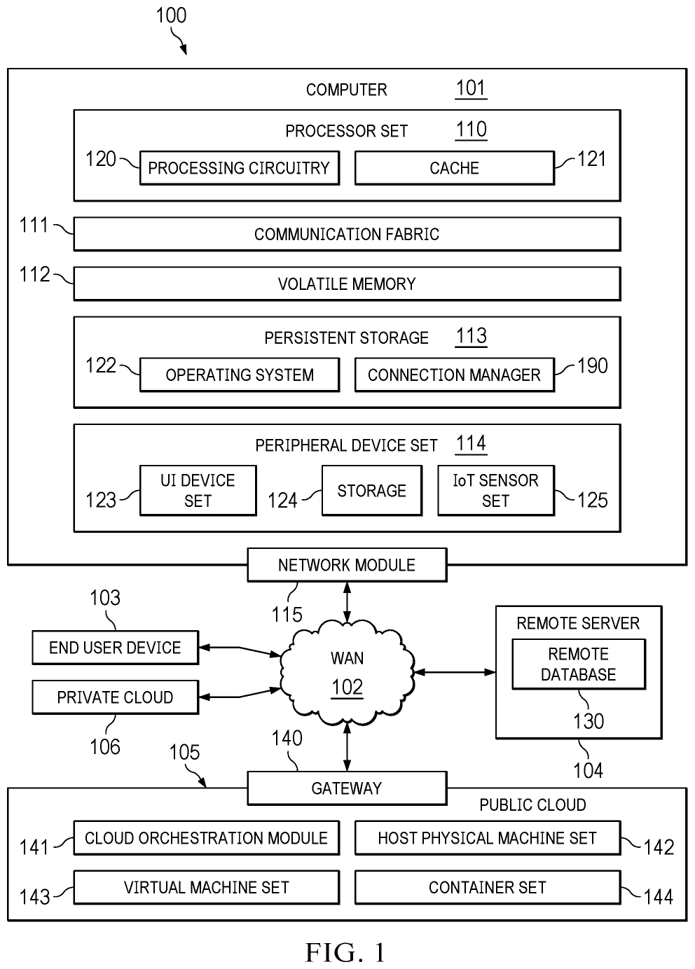

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as connection manager 190. In addition to connection manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and connection manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in connection manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in connection manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, the illustrative embodiments recognize and take into account that some JDBC drivers can use large amounts of memory per prepared statement that results in users or customers running out of memory because of the number of pooled prepared statements. However, disabling statement pooling to avoid the memory issue is undesirable because of a loss of performance.

One solution involves updating application code in places where particular prepared statements are used infrequently. Hints can be included that pooling should be avoided for particular prepared statements. This change can be helpful where particular prepared statements are used infrequently and take up slots in a prepared statement pool. This feature can reduce the overhead of unwanted discard and re-create processing of prepared statements that are used infrequently. However, this solution involves changing the application code which is often undesirable.

Another solution involves analyzing prepared statements with different code paths through the application. A code path is a path of execution through application logic for an application. Updates can be made to the application code for these paths to either use a dedicated data source or connection label. In this manner, the connection pool can be partitioned into restricted paths that allow reducing the maximum full-size for prepared statement pools. However, using dedicated data sources can lead to increasing the size of the connection pool to provide an ability to process requests. This solution can overwhelm a database backend causing the database backend to run out of connections. The label approach is not within many standards and will lose out in the connection pooling and in turn other services provided by the application server.

Other solutions involve reducing the maximum connection pool size, the maximum prepared statement pool size, or both to reduce memory usage. The solutions, however, are not desirable because of the degradation in performance through the reduction in pool sizes.

Thus, one or more illustrative examples can collect data from the thread stack present at the time a request is made for a connection. This data is used to optimize the matching of connections within a connection pool according to predicted sets of prepared statement utilization. As a result, one or more illustrative examples can enable the maximum pool size to be reduced without requiring special analysis of prepared statement usage. Further, the illustrative examples avoid needing changes to application code.

The illustrative examples provide a method, apparatus, system, a computer program product for managing connections in a connection pool. In one example, a computer system creates a modified call stack for a connection request in response to receiving the connection request. The modified call stack comprises elements that call prepared statements that are part of an application logic for the connection request. The computer system identifies a group of potential connections from the connections in the connection pool that matches the connection request. The group of potential connections is associated with a group of associated modified call stacks that call the prepared statements. The computer system determines a group of weighted match scores for the group of associated modified call stacks from a comparison of the modified call stack with the group of associated modified call stacks. The computer system selects a connection from the group of potential connections based on a highest weighted match score in the group of weighted match scores

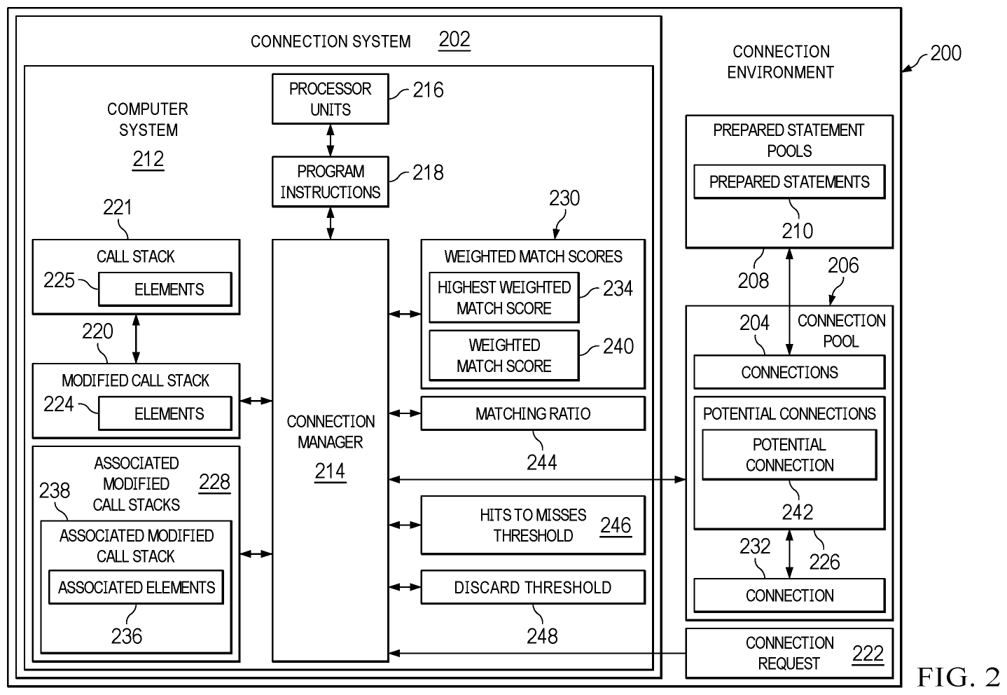

With reference now to FIG. 2, a block diagram of a connection environment is depicted in accordance with an illustrative embodiment. In this illustrative example, connection environment 200 includes components that can be implemented in hardware such as the hardware shown in computing environment 100 in FIG. 1.

In this illustrative example, connection system 202 in connection environment 200 can operate to manage connections 204 in connection pool 206. For example, connection system 202 can manage the allocation of connections 204 in connection pool 206.

In this example, connections 204 in connection pool 206 are associated with prepared statement pools 208. For example, each connection in connections 204 has a prepared statement pool in prepared statement pools 208. Prepared statement pools 208 have prepared statements 210.

In this illustrative example, a prepared statement is a precompiled template in which constant values can be substituted during execution of the prepared statements. In one example, a prepared statement is a precompiled query statement that can be executed multiple times. These prepared statements can be, for example, sequential query logic (SQL) data manipulation language (DML) statements such as insert, select, or update. The use of prepared statements 210 can increase efficiency through the caching of statements that are used repeatedly. For example, the caching of these prepared statements in prepared statement pools 208 can result in increased efficiency in sending requests to a database.

In this illustrative example, connection system 202 comprises a number of different components. As depicted in this example, connection system 202 has computer system 212 and connection manager 214.

Connection manager 214 can be implemented in software, hardware, firmware or a combination thereof. When software is used, the operations performed by connection manager 214 can be implemented in program instructions configured to run on hardware, such as a processor unit. When firmware is used, the operations performed by connection manager 214 can be implemented in program instructions and data and stored in persistent memory to run on a processor unit. When hardware is employed, the hardware can include circuits that operate to perform the operations in connection manager 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond and process instructions and program instructions that operate a computer. A processor unit can be implemented using processor set 110 in FIG. 1. When the number of processor units 216 execute program instructions 218 for a process, the number of processor units 216 can be one or more processor units that are on the same computer or on different computers. In other words, the process can be distributed between processor units 216 on the same or different computers in computer system 212. Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, connection manager 214 operates to manage connections 204 in connection pool 206. In this example, connection manager 214 creates modified call stack 220 for connection request 222 in response to receiving the connection request 222. In this example, modified call stack 220 is created from call stack 221. In this depicted example, call stack 221 is the call stack that is present at the time of connection request 222 is made. In this example, call stack 221 is the call stack present at the time an application request is made through connection request 222. This call stack can also be referred to as a thread stack.

In one illustrative example, connection manager 214 creates modified call stack 220 by retrieving elements 225 from call stack 221 in response to receiving connection request 222. Connection manager 214 removes each element in elements 225 that is known to not be a part of the application logic for connection request 222. Connection manager 214 places the remaining elements in modified call stack 220. These remaining elements are elements 224. Elements 224 can be a subset of elements 225.

In another illustrative example, connection manager 214 creates modified call stack 220 by retrieving elements 225 from call stack 221 in response to receiving the connection request 222. In this example, connection manager 214 adds elements 225 that are known to be part of the application logic for connection request 222 to modified call stack 220 such that modified call stack 220 has elements 224.

In this example, modified call stack 220 comprises elements 224 that call prepared statements 210 that are part of an application logic for connection request 222. Elements 224 can directly or indirectly call prepared statements 210. For example, an element can call a method that calls another method in a chain of calls that eventually uses a prepared statement in a request for data. In this example, elements 224 in modified call stack 220 are selected in a manner that removes extraneous elements that are not directly related to the logic in the application for connection request 222.

Connection manager 214 identifies a group of potential connections 226 from the connections 204 in the connection pool 206 that matches connection request 222. In this illustrative example, the group of potential connections 226 is one or more connections 204 that match connection request 222. These connections are labeled as “potential connections” because further analysis is needed to select a connection from the group of potential connections 226 for use.

In this example, the group of potential connections 226 is associated with a group of associated modified call stacks 228 that call prepared statements 210. In this example, each potential connection in the group of potential connections 226 is associated with an associated modified call stack in the group of associated modified call stacks 228. These modified call stacks in the group of associated modified call stacks 228 were generated at the time requests were made for the connections in the group of potential connections 226.

In this illustrative example, connection manager 214 determines a group of weighted match scores 230 for the group of associated modified call stacks 228. The group of weighted match scores 230 is determined from modified call stack 220 and the group of associated modified call stacks 228. In this example, modified call stack 220 is compared with each modified call stack in the group of associated modified call stacks 228 to obtain a weighted match score for each comparison to form the group of weighted match scores 230. This comparison determines the level of matching between elements that request prepared statements in modified call stack 220 and the group of associated modified call stacks 228. As the level of matching between elements increases, the weighted match score increases for that comparison.

For example, connection manager 214 can determine a weighted match score in the group of weighted match scores 230 by comparing elements 224 in modified call stack 220 with associated elements 236 in associated modified call stack 238. Connection manager 214 can assign weighted match score 240 to associated modified call stack 238 based on matches of elements 224 in modified call stack 221 with associated elements 236 in associated modified call stack 238. This comparison of elements 224 in modified call stack 220 can be made with each associated modified call stack in associated modified call stacks 228 to obtain the group of weighted match scores 230.

In this example, weighted match score 240 is higher for a first match between more recent elements in modified call stack 220 and the associated elements 236 in associated modified call stack 238 as compared to a second match between older elements in modified call stack 220 and associated elements 236 in associated modified call stack 238. This comparison can be performed using a recency bias such that more recent elements that are higher up in the stack are given a higher weighting as compared to older elements that are farther down in the stack.

Connection manager 214 selects connection 232 from the group of potential connections 226 based on a highest weighted match score 234 in the group of weighted match scores 230. In the illustrative example, connection manager 214 can also exclude a potential connection and potential connections 226 as part of the process of selecting connection 232 from the group of potential connections 226.

In one example, connection manager 214 can exclude potential connection 242 from the group of potential connections 226 in response to associated modified call stack 238 for potential connection 242 being excluded because of a matching ratio 244 for a matching of prepared statements 210 in a prepared statement pool for potential connection 242 that is less than hits to misses threshold 246. In this example, matching ratio 244 is a ratio of hits to misses with respect to prepared statements 210 in the comparison of elements 224 and modified call stack 220 with associated elements 236 in associated modified call stack 238.

In this example. hits to misses threshold 246 can be selected as a value that indicates that good matches are present between prepared statements in a prepared statement pool and the request for prepared statements from the prepared statement pool during actual use of a connection for a connection. For example, hits to misses threshold 246 can be 0.85, 0.9, or some other value indicating that good matches are present.

In another illustrative example, connection manager 214 can exclude potential connection 242 from the group of potential connections 226 in response to an associated modified call stack 238 for potential connection 242 being excluded because of matching ratio 244 for matching of prepared statements in a prepared statement pool for the potential connection 242 that is equal to or greater than hits to misses threshold 246 but a number of times prepared statements are discarded from prepared statement pool is greater than discard threshold 248. In this example, discard threshold 248 is the number of times that a prepared statement in a prepared statement pool is discarded or removed from the prepared statement pool. This threshold can be set to indicate when the number of discards of the prepared statements is greater than desired. The particular value for this threshold can be based on when memory usage or performance issues can occur based on discarded prepared statements.

In another illustrative example, connection manager 214 can change the size of a prepared statement pool to increase performance. For example, connection manager 214 can increase a size of a prepared statement pool in response to a matching for a matching of prepared statements in a prepared statement pool for potential connection 242 that is equal to or greater than hits to misses threshold 246 and a number of times prepared statements are discarded is less than discard threshold 248. In this example, increasing the size of the prepared statement pool when the matching ratio indicates that the matches are good can result in decreased matching with fewer discards or no discards of prepared statements.

In one illustrative example, one or more solutions are present that overcome a problem with memory use associated with connections associated with prepared statement pools. As a result, one or more solutions may provide enable managing connections in a connection pool in which each connection is associated with a prepared statement pool. In one or more illustrative examples, modified call stacks are used to determine weightings for prepared statement usage.

In one or more illustrative examples, the maximum prepared statement pool size can be reduced through this type of connection management. In one illustrative example, each respective prepared statement pool associated with each pool connection needs only to retain a sufficient number of prepared statements to meet the use of pattern that pertains to a particular set of similar modified call stacks. Further, one or more illustrative examples can involve dynamically assigning or changing the maximum size of the statement pool. In this manner, user input and user analysis are unnecessary to reduce memory usage by prepared statements in prepared statement pools. Additionally, the management of connection pools associated with a prepared statement pools can be performed without making changes to an application or a need for user analysis to make adjustments to the prepared statement pool size.

Computer system 212 can be configured to perform at least one of the steps, operations, or actions described in the different illustrative examples using software, hardware, firmware or a combination thereof. As a result, computer system 212 operates as a special purpose computer system in which connection manager 214 in computer system 212 enables increase performance in managing connections. In particular, connection manager 214 transforms computer system 212 into a special purpose computer system as compared to currently available general computer systems that do not have connection manager 214.

In the illustrative example, the use of connection manager 214 in computer system 212 integrates processes into a practical application for a method of managing connections that increases the performance of computer system 212. In other words, connection manager 214 in computer system 212 is directed to a practical application of processes integrated into connection manager 214 in computer system 212 that manages connections based on information in a call stack at the time a request is made to access an application. In the illustrative example, connection manager 214 enables optimizing the matching of connections within a connection pool based on predicted sets of prepared statement utilization. The prepared statement utilization can be determined through analyzing a modified call stack with elements representing logic for the application. These elements can be calls to prepared statements. With the analysis of the information from the call stack and the call stacks associated with connections in the connection pool, the maximum full-size can be reduced while maintaining the desired level performance without requiring special knowledge or code updates to the application.

The illustration of connection environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, connection manager 214 can manage one or more connection pools in addition to connection pool 206.

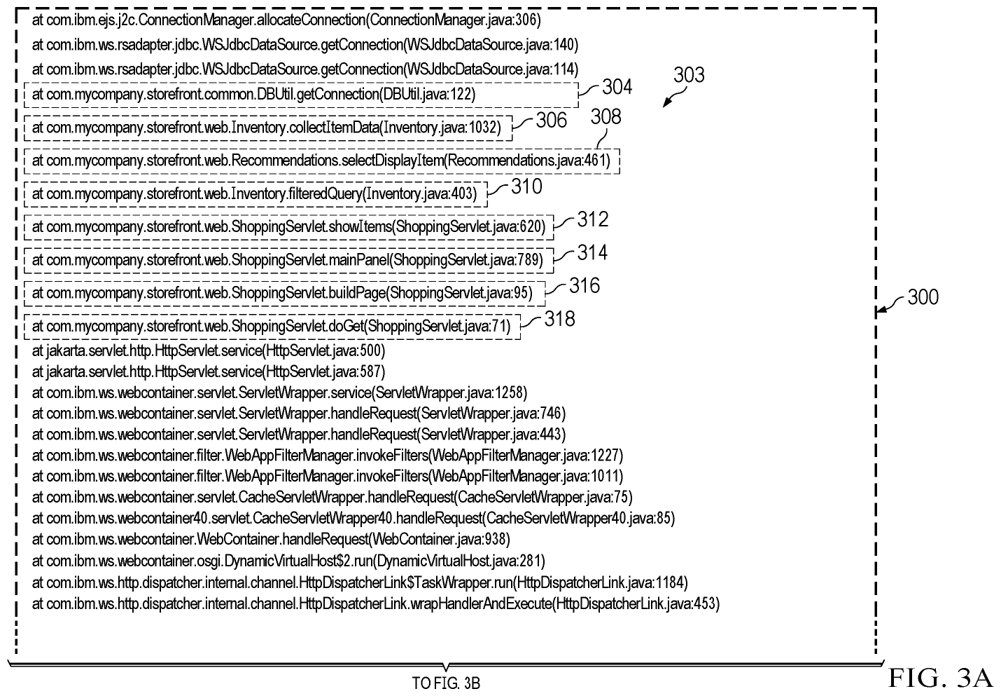

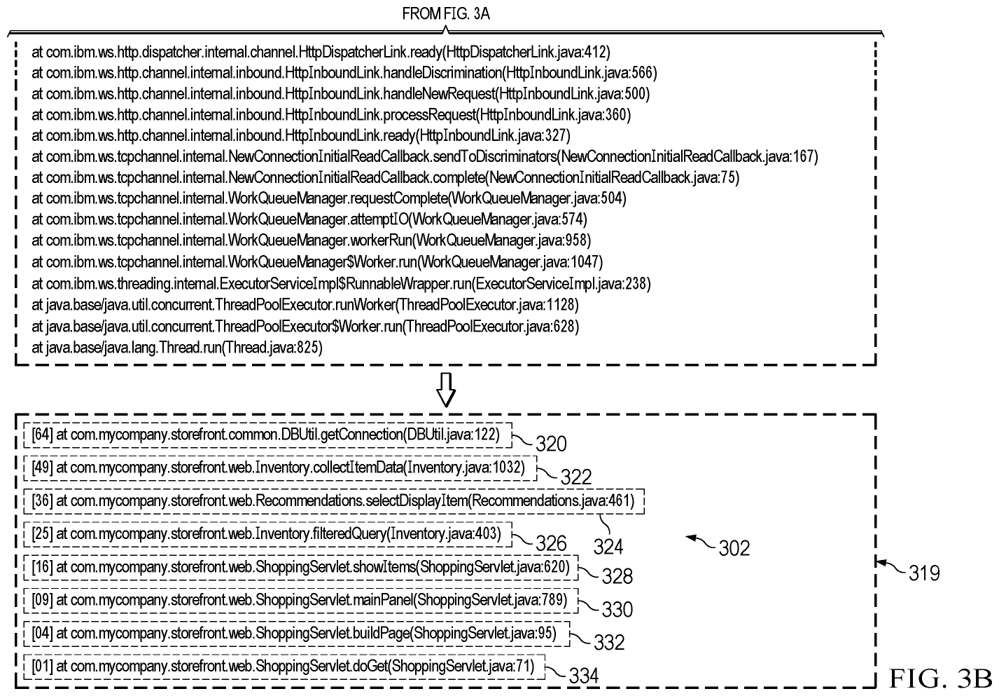

With reference to FIGS. 3A-3B, a diagram illustrating generation of a modified call stack is depicted in accordance with an illustrative embodiment. In the illustrative examples, the same reference numeral may be used in more than one figure. This reuse of a reference numeral in different figures represents the same element in the different figures.

As depicted, modified call stack 302 is generated from call stack 300. In this illustrative example, modified call stack 302 is an example of modified call stack 220 in FIG. 2 and call stack 300 is an example of call stack 221 in FIG. 2.

In this example, call stack 300 is present for a connection request and includes elements 303, such as element 304, element 306, element 308, element 310, element 312, element 314, element 316, and element 318.

Call stack 300 can be processed to generate a modified call stack 302 by removing elements that are known to not be part of the application logic for the connection. For example, classes with packages provided by Java packages, Java EE packages, Jakarta packages, or similar specifications are excluded from call stack 300. In addition, classes with packages provided by the application server or a third party package that does not access the database are excluded from call stack 300.

As a result, call stack 300 has been reduced to generate a modified call stack 302. Modified call stack only includes associated elements that are part of the application logic for the connection. In this example, modified call stack 302 includes associated elements 319 such as associated element 320, associated element 322, associated element 324, associated element 326, associated element 328, associated element 330, associated element 332, and associated element 334. These associated elements correspond to element 304, element 306, element 308, element 310, element 312, element 314, element 316, and element 318 in call stack 300, respectively.

Associated elements 319 in modified call stack 302 are assigned different weightings as part of determining the weighted match score. In this illustrative example, the element that is furthest from the connection request is assigned with a weighting of 1. Subsequent associated elements in modified call stack 302 are incrementally assigned with weightings that are 1 higher than the previous associated element so that the associated element performing the connection request has the highest weighting.

For example, in modified call stack 302, associated element 334 is assigned a weighting of 1, associated element 332 is assigned a weighting of 2, associated element 330 is assigned a weighting of 3, associated element 328 is assigned a weighting of 4, associated element 326 is assigned a weighting of 5, associated element 324 is assigned a weighting of 6, associated element 322 is assigned a weighting of 7, and associated element 320 is assigned a weighting of 8.

In this depicted example, the weighted match score for the comparison of two modified call stacks is initially set as zero and subsequently calculated based on the number of common associated elements between the two modified call stacks. In other words, if an associated element can be found in both modified call stacks, the square of weighting of the associated element will be added to the weighted match score.

For example, associated element 334 contributes a score value of 1 to the weighted match score, if associated element 334 is found in both modified call stacks. Associated element 332 contributes a score value of 4 to the weighted match score, if associated element 330 is found in both modified call stacks, and associated element 330 contributes a score value of 9 to the weighted match score. If associated element 320 is found in both modified call stacks, associated element 320 contributes a score value of 64 to the weighted match score.

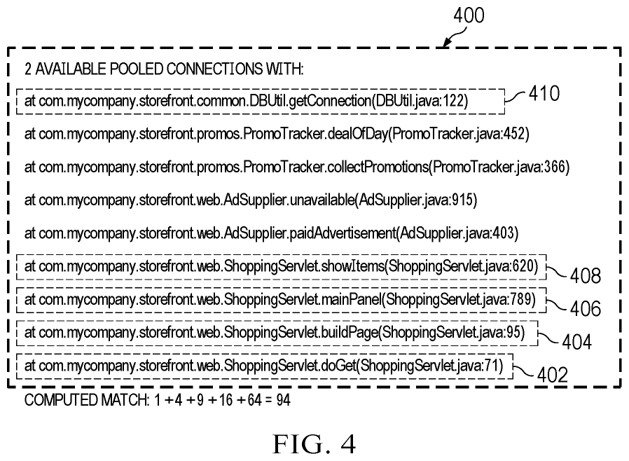

With reference to FIG. 4, a diagram illustrating determining a weighted match score between modified call stacks is depicted in accordance with an illustrative embodiment. Potential connections are identified for modified call stack 302. In this illustrative example, two potential connections with associated modified call stacks are identified as potential matches for the connection request with modified call stack 302. In this example, each of the two potential connections has a modified call stack with the elements shown in associated modified call stack 400. In other words, each of the potential connections has a modified call stack with the same elements as depicted for associated modified call stack 400 and associated modified call stack 400 is not shared between these potential connections.

In this illustrative example, a weighted match score can be calculated for associated modified call stack 400 and modified call stack 302. The weighted match score between the two modified call stacks can be calculated by comparing associated elements in both associated modified call stack. For example, associated modified call stack 400 and modified call stack 302 have 5 associated elements in common.

In this example, associated element 402 corresponds to associated element 334, associated element 404 corresponds to associated element 332, associated element 406 corresponds to associated element 330, associated element 408 corresponds to associated element 328, and associated element 410 corresponds to associated element 320. Therefore, the weighted match score for associated modified call stack 400 and modified call stack 302 is calculated by summing squares of weightings for associated element 334, associated element 332, associated element 330, associated element 328, and associated element 320. As a result, the weighted match score for associated modified call stack 400 and modified call stack 302 is 94. Both potential connections have the same weight match score in this example.

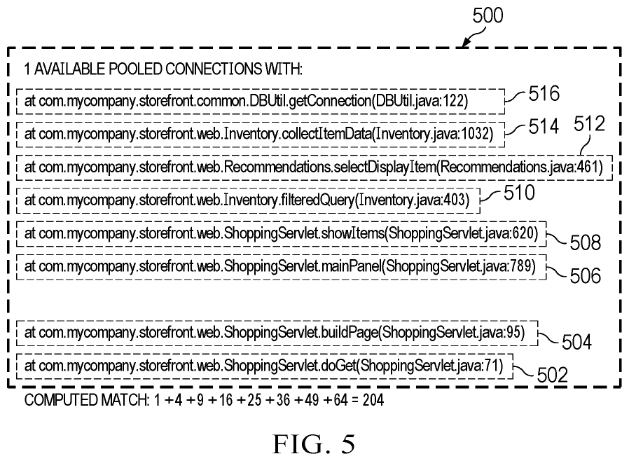

With reference to FIG. 5, a diagram illustrating determining a weighted match score between modified call stacks is depicted in accordance with an illustrative embodiment. In this illustrative example, one potential connection with associated modified call stack 500 is identified as a potential match for the connection request for modified call stack 302. Similarly, the weighted match score for associated modified call stack 500 and modified call stack 302 is calculated by the squares of weightings for associated elements that the two modified call stack have in common. In this example, associated modified call stack 500 has 8 associated elements that are found in modified call stack 302. Therefore, the weighted match score for associated modified call stack 500 and modified call stack 302 is 204. This score is the sum of squares of the weightings for associated element 334, associated element 332, associated element 330, associated element 328, associated element 326, associated element 324, associated element 322, and associated element 320. These associated elements correspond to element 502, element 504, element 506, element 508, element 510, element 512, element 514, and element 516 in call stack 500, respectively.

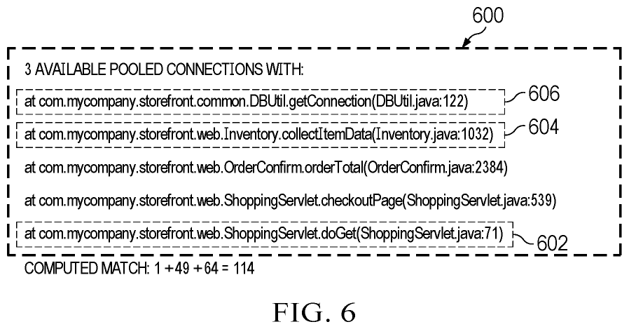

With reference to FIG. 6, a diagram illustrating determining a weighted match score between modified call stacks is depicted in accordance with an illustrative embodiment. In this illustrative example, three potential connections with associated modified call stacks are identified as potential matches for the connection request with modified call stack 302. In this example, each of the three potential connections has a modified call stack with the elements depicted for associated modified call stack 600. In other words, each of the potential connections has a modified call stack with the same elements as depicted in associated modified call stack 600 and associated modified call stack 600 is not shared between these potential connections.

As depicted, the weighted match score for associated modified call stack 600 and modified call stack 302 is calculated by summing the squares of weightings of shared associated elements. In this example, associated modified call stack 600 has 3 associated elements that are be found in modified call stack 302. Therefore, the weighted match score for associated modified call stack 600 and modified call stack 302 is 114, which is the sum of squares of the weightings for associated elements 334, 322, and 320. These associated elements correspond to element 602, element 604, and element 606 in call stack 600, respectively. As result, all three of the potential connections have the same weighted match score in this example.

In an illustrative example, if a partial match is found between two modified call stacks, the weightings and modified call stack associated with the potential connection are adjusted to correspond to the change in usage that will end up being reflected in the distribution of pooled prepared statements. In other words, the weighting of elements in a modified call stack can adjust and adapt to the changes in usage patterns over time.

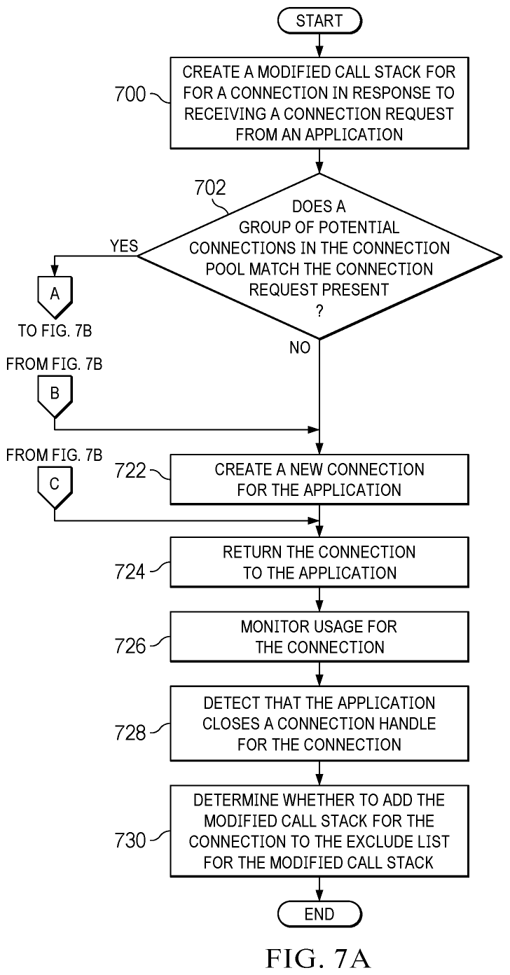

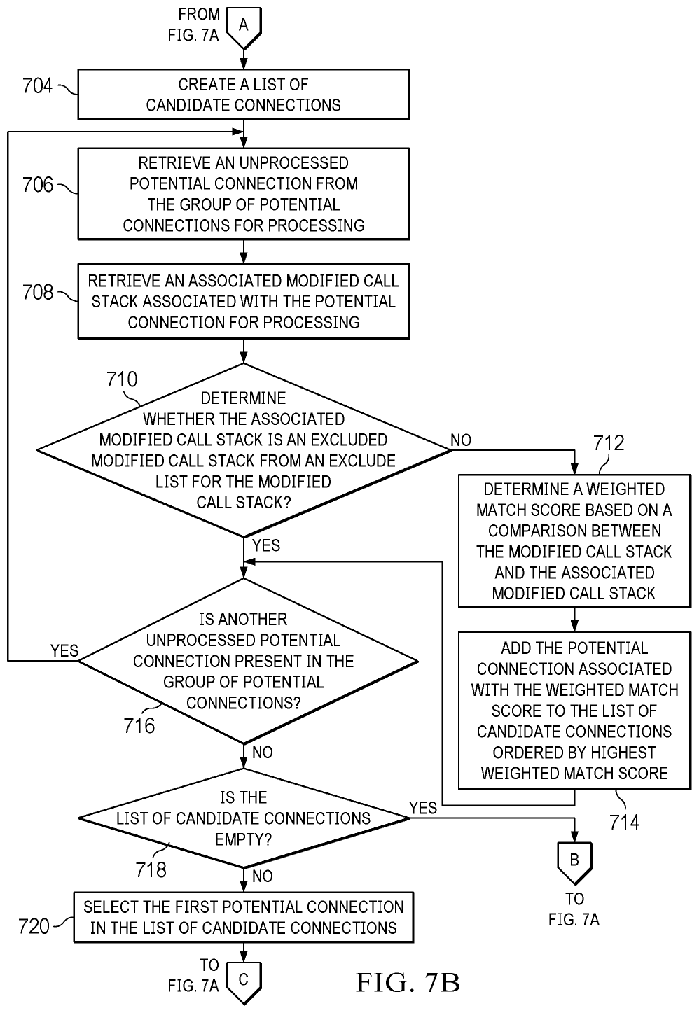

Turning next to FIGS. 7A-7B, a flowchart of a process for managing connections in a connection pool is depicted in accordance with an illustrative embodiment. The process in FIGS. 7A-7B can be implemented in hardware, software, or both. When implemented in software, the process can take the form of program instructions that is run by one of more processor units located in one or more hardware devices in one or more computer systems. For example, the process can be implemented in connection manager 214 in computer system 212 in FIG. 2.

The process begins by creating a modified call stack for a connection request in response to receiving a connection request from an application (step 700). As depicted, the modified call stack comprises elements that call prepared statements that are part of an application logic for the connection request. Other elements that are not part of the application logic are not used in the modified call stack.

The process determines whether a group of potential connections in the connection pool that matches the connection request is present (step 702). In step 702, each connection with a match to the connection request is a potential connection in the group of potential connections. A potential connection in this step has an associated modified call stack. This associated modified call stack for the potential connection is a modified call stack that was created at the time the request was made for the potential connection.

If a group of potential connections identified from the connection pool matches the connection request, the process creates a list of candidate connections (step 704). In step 704, the list of candidate connections is initially an empty list. This list is used to store potential connections identified as being candidates for use by the connection request.

The process retrieves an unprocessed potential connection from the group of potential connections for processing (step 706). In step 706, a potential connection is an unprocessed connection before it is evaluated in this process. The process retrieves an associated modified call stack associated with the potential connection retrieved for processing (step 708).

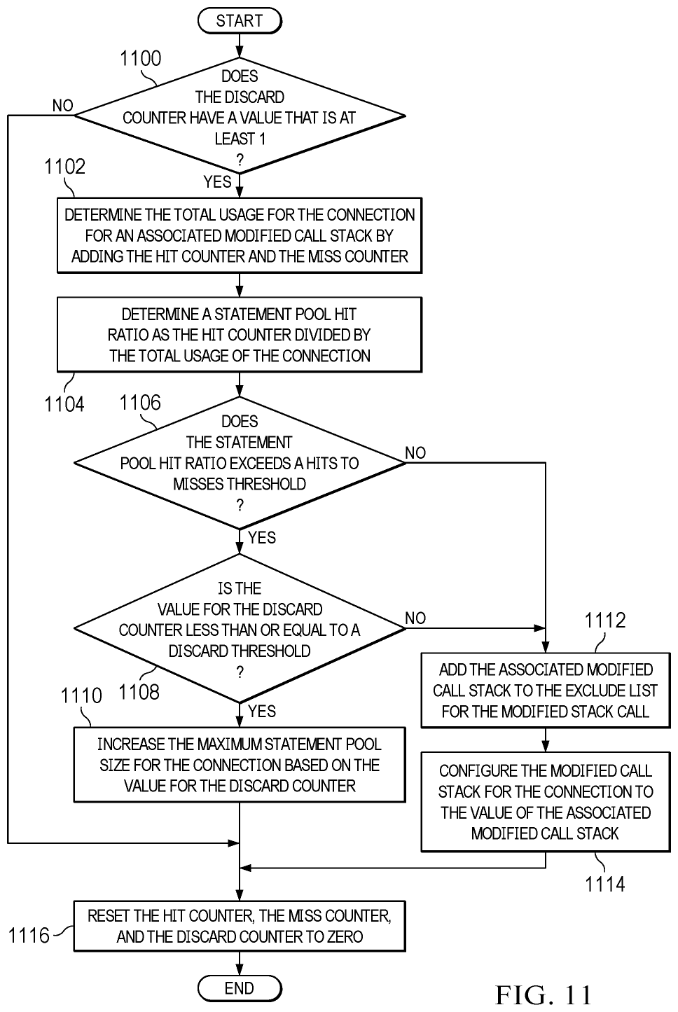

The process determines whether the associated modified call stack is an excluded modified call stack in an exclude list for the modified call stack (step 710). In step 710, the exclude list identifies associated modified call stacks that have been determined to be not effective matches for use with connection requests. This analysis of determining whether to exclude modified call stacks is described in the flowchart in FIG. 11 below. As a result, a potential connection associated with excluded modified call stacks is not a good candidate for the connection request and the connection is not added to the list of candidate connections.

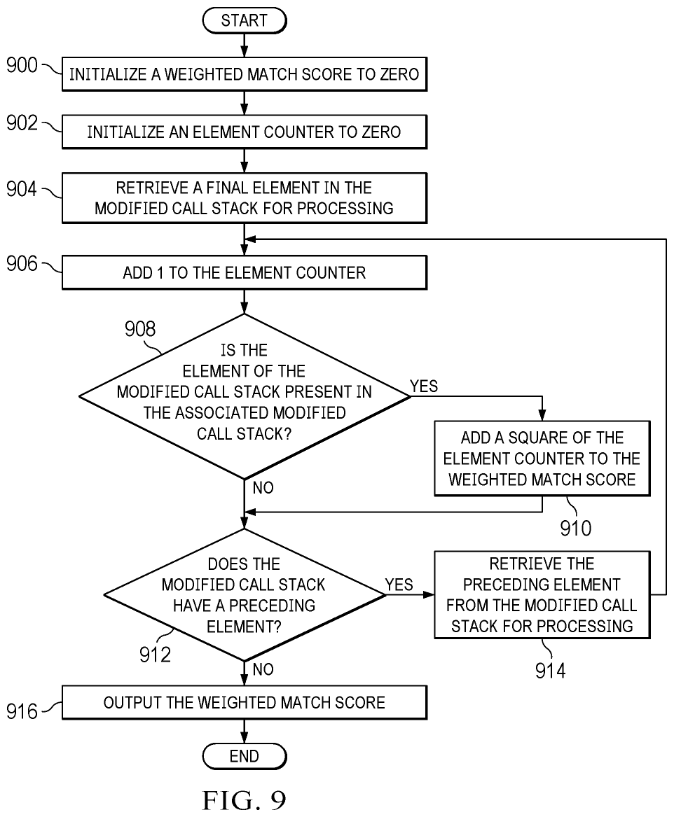

If the associated modified call stack is not on the exclude list for modified call stacks, the process determines a weighted match score based on a comparison between the modified call stack and the associated modified call stack (step 712). In step 712, the weighted match score can be determined based on matches of the elements in the modified call stack and the associated elements in the associated modified call stack. An example of a process for determining a weighted match score is described below in FIG. 9.

The process adds the potential connection associated with the weighted match score to the list of candidate connections ordered by the highest weighted match score (step 714). In step 714, the list with this ordering results in the connection with the highest weighted match score being first in the list while the connection with the lowest weighted match score is at the end of the list. As a result, potential connections with higher weighted match scores are higher in the list.

The process then determines whether another unprocessed potential connection is present in the group of potential connections (step 716). If another unprocessed potential connection is present for processing, the process proceeds to step 706. Otherwise, the process determines whether the list of candidate connections is empty (step 718). In step 718, the list of candidate connections is empty if all identified potential connections are on the exclude list for the modified call stack.

If the list of candidate connections is not empty, the process selects the first potential connection in the list of candidate connections (step 720). In step 720, the list is ordered by the highest weighted match score. As result, the first potential connection in the list is the potential connection with the highest weighted match score in the potential connections in the list. The process then returns the connection to the application (step 724). With reference again to step 718, if the list is empty, the process proceeds to step 722.

With reference again to step 710, if the associated modified call stack is on the exclude list for modified call stacks, the process proceeds to step 716 and determines whether another unprocessed potential connection is present in the group of potential connections for processing. As a result, the potential connection with the associated modified call stack on the exclude list is not added to the list of candidate connections for the connection request.

With reference again to step 702, if potential connections from the connection pool that match the connection request are absent, the process creates a new connection for the application (step 722). The process returns the connection to the application (step 724).

When a connection is first created, a modified call stack is created for the connection from the request that caused connection to be created. That modified call stack remains associated with that connection unless the modified call stack is replaced due to an unfavorable hit ratio with at least one discard or unfavorable higher number of discards as described below in step 1114 in FIG. 11. When a connection request can be fulfilled by reusing a connection from a list of potential connections, and the modified call stack of the connection request does not perfectly match the modified call stack of the chosen potential connection, there is no change to the potential connection's modified stack at this point.

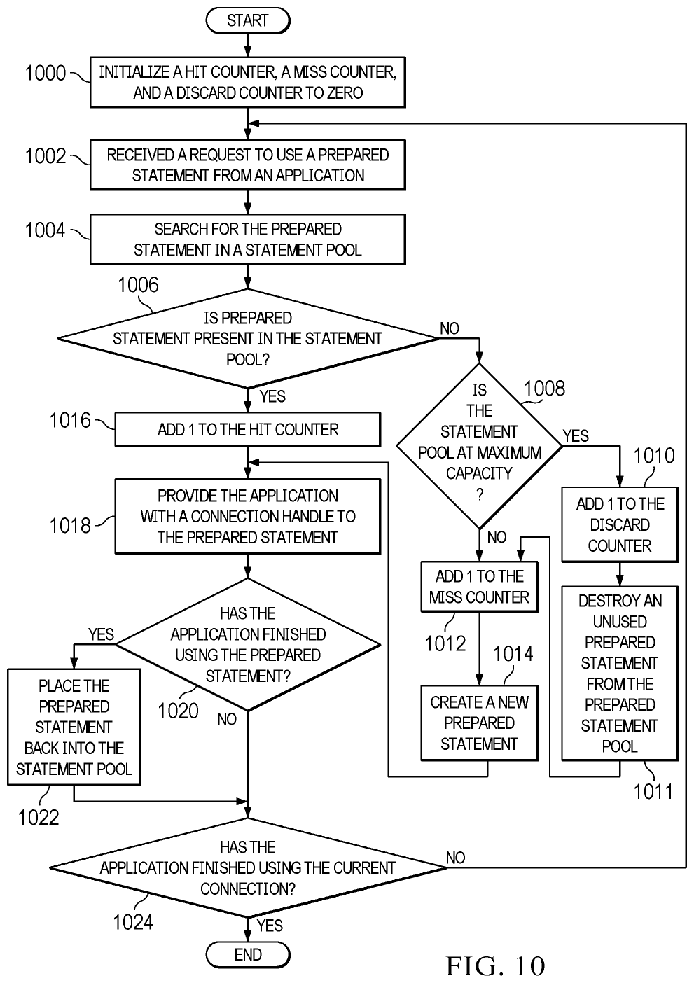

The process monitors usage for the connection (step 726). In step 726, the process monitors the usage of new connection to determine the effectiveness of the connection that has been returned for use by the application. An example of this monitoring is described in the process in FIG. 10 below. The process detects that the application closes a connection handle for the connection (step 728). The process determines whether to add the modified call stack for the connection to the exclude list for the modified call stack (step 730). The process terminates thereafter. In step 730, the connection can be excluded when the matching ratio for matchings of prepared statements in the prepared statement pool for the new connection is less than a hits to misses threshold defined by the user.

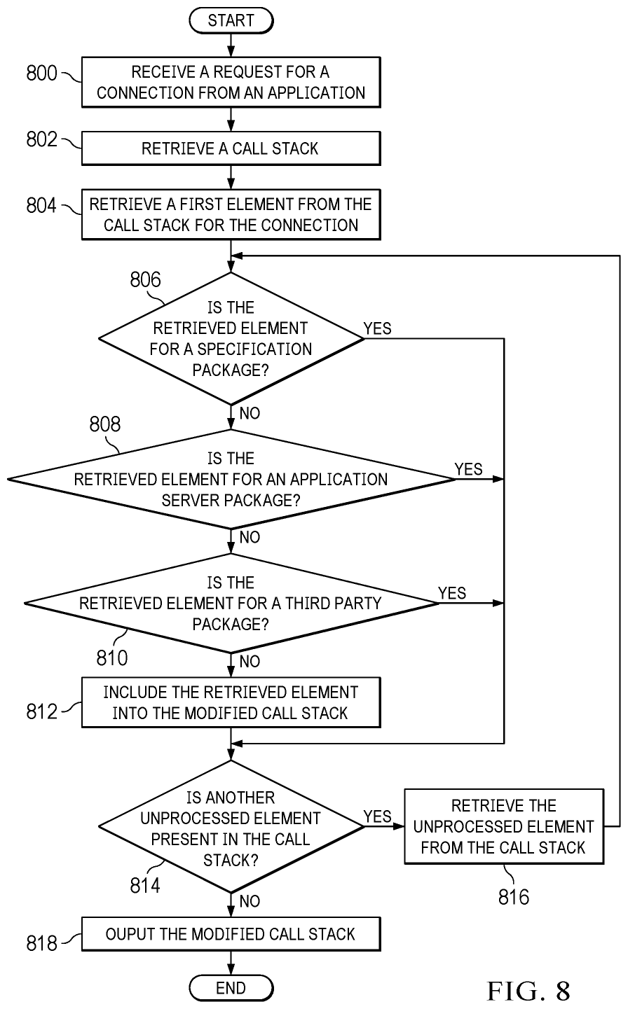

With reference to FIG. 8, a flowchart of a process for creating a modified call stack is depicted in accordance with an illustrative embodiment. The process in FIG. 8 is an example of one implementation for step 700 in FIG. 7A-7B.

The process begins by receiving a request for a connection from an application (step 800). The process retrieves a call stack (step 802). In step 802, the call stack is for the connection request from the application and can be obtained from the programming language used such as Java. The process retrieves a first element from the call stack for the connection (step 804).

The process determines whether the retrieved element of the call stack is for a specification package (step 806). In step 806, specification packages can be Java packages, Java EE packages, Javax packages, Jakarta packages, or any package that provides specification code. If the retrieved element of the call stack is not for a specification package, the process determines whether the retrieved element of the call stack is for an application server package (step 808). In step 808, elements by application server package are excluded from the call stack because those elements are products of the vendor and do not perform application logic.

If the retrieved element of the call stack is not by an application server package, the process determines whether the retrieved element of the call stack is for a third party package (step 810). In step 810, elements by the third party packages do not contribute to the application logic and are therefore excluded from the call stack.

If the retrieved element of the call stack is not for a third party package, the process includes the retrieved element into the modified call stack (step 812). The process then determines whether another unprocessed element is present in the call stack (step 814). If an unprocessed element is present, the process retrieves the unprocessed element from the call stack (step 816). In step 816, this element is the next element from the top of the call stack. The process then returns to step 806 and repeats the process from step 806 to step 814 until all elements in the call stack are processed.

With reference again to step 806, if the retrieved element is for a specification package, the process proceeds to step 814. Referring back to step 808, if the retrieved element is for an application server package, the process proceeds to step 814. Referring again to step 810, if the retrieved element is for a third party package, the process also proceeds to step 814. In this case, determinations in step 806, step 808, and step 814 indicate that the elements are not part of the logic for the application. As a result, these elements are not included in the modified call stack.

With reference again to step 814, if an unprocessed element is not present, the process outputs the modified call stack (step 818). The process terminates thereafter.

With reference to FIG. 9, a flowchart of a process for determining a weighted match score between a modified call stack and an associated modified call stack is depicted in accordance with an illustrative embodiment. The process in FIG. 9 is an example of one implementation for step 712 in FIG. 7A-7B.

The process initializes a weighted match score to zero (step 900). In step 900, the score is a match score for matching between elements in the modified call stack for the connection request and associated elements in an associated modified call stack for a potential connection that is being considered. The process initializes an element counter to zero (step 902). In this step, element counter is a numerical representation of the relative location for associated elements in the modified call stack.

The process retrieves a final element in the modified call stack for processing (step 904). As depicted, the location of an element in the modified call stack corresponds to the weight of the element. In this illustrative example, the final element of modified call stack corresponds to the element that is furthest from connection request. This element has the lowest weight.

The process adds 1 to the element counter (step 906). The process determines whether the element of the modified call stack is present in the associated modified call stack (step 908). If the element of modified call stack is present in the associated modified call stack, the process adds a square of the element counter to the weighted match score (step 910). The process determines whether the modified call stack has a preceding element (step 912). If the modified call stack has a preceding element, the process retrieves the preceding element from the modified call stack for processing (step 914). The process proceeds to step 906 to add 1 to the counter of elements. In this illustrative example, the process repeats steps 906 to 914 until all associated elements in the modified call stack are processed.

In step 912, if the modified call stack does not have a preceding element, the process outputs the weighted match score (step 916). The process terminates thereafter. With reference again to step 908, if the final element of modified call stack is not present in the associated modified call stack, the process proceeds to step 912 as described above.

With reference to FIG. 10, a flowchart of a process for monitoring usages of connections is depicted in accordance with an illustrative embodiment. The process in FIG. 10 is an example of one implementation for step 728 in FIGS. 7A-7B.

The process begins by initializing a hit counter, a miss counter, and a discard counter to zero (step 1000). The process receives a request to use a prepared statement from an application (step 1002). The process searches for the prepared statement in a statement pool (step 1004). The process determines whether the prepared statement is present in the statement pool (step 1006). If the prepared statement is present in the statement pool, the process adds 1 to the hit counter (step 1016). The process provides application with a connection handle to the prepared statement (step 1018).

The process determines whether the application has finished using the prepared statement (step 1020). If the application has not finished using the prepared statement, the process determines whether the application has finished using the current connection (step 1024). If the application is not finished using the current connection, the process returns to step 1002. Otherwise, the process terminates.

With reference again to step 1020, if the application has finished using the prepared statement, the process places the prepared statement back into the statement pool (step 1022). The process then proceeds to step 1024.

With reference again to step 1006, if the prepared statement is not present in the statement pool, the process determines whether the statement pool is at maximum capacity (step 1008). If the statement pool is not at maximum capacity, the process adds 1 to the miss counter (step 1012). The process creates a new prepared statement (step 1014). The process then proceeds to step 1018 as described above. Turning back to step 1008, if the statement pool is at maximum capacity, the process adds 1 to the discard counter (step 1010). The process destroys an unused prepared statement from the prepared statement pool (step 1011). The process then proceeds to step 1012.

With reference to FIG. 11, a flowchart of a process for determining the exclude list from usage of connection for an associated modified call stack is depicted in accordance with an illustrative embodiment. The process in FIG. 11 is an example of one implementation for step 710 in FIG. 7A-7B.

The process begins by determining whether the discard counter has a value that is at least 1 (step 1100). If the discard counter is at least 1, the process determines the total usage for the connection for an associated modified call stack by adding the hit counter and the miss counter (step 1102).

The process determines a statement pool hit ratio as the hit counter divided by the total usage of the connection (step 1104). The process then determines whether the statement pool hit ratio exceeds a hits to misses threshold (step 1106). This hits to misses threshold can be based on what ratio of hits to misses results in good matching for the connection. In one illustrative example, the hits to misses ratio can be 0.9. In another example, this ratio can be 0.85.

If the statement pool ratio exceeds the hits to misses threshold, the process determines whether the value for the discard counter is less than or equal to a discard threshold (step 1108). In step 1108, the discard threshold can be selected based on when discards are considered to be present. This threshold can be selected based on the amount of growth that would be tolerated for an individual statement pool in order for its connection to cover multiple similar usage patterns rather than requiring a separate connection for each pattern. This threshold can be, for example, a number, such as less than 5. The threshold can be fine-tuned by experimenting with different thresholds and initial maximum statement pool sizes and observing memory utilization as well as metrics for discards over time to identify which settings are optimal. In other example, the threshold is a default threshold that is chosen by the connection manager.

In one illustrative example, the discard threshold can be set to 2. If the value for the discard counter is less than or equal to the discard threshold, the process increases the maximum statement pool size for the connection based on the value for the discard counter (step 1110). In step 1110, the increase in maximum pool size is selected to increase the matching while reducing discards. The goal in increasing the maximum pool size can be selected as a value that obtains 100% matching with no discards. The process resets the hit counter, the miss counter, and the discard counter to zero (step 1116). The process terminates thereafter.

With reference again to step 1106, if the statement pool hit ratio does not exceed the hits to misses threshold, the process adds the associated modified call stack to the exclude list for the modified call stacks (step 1112). The process configures the modified call stack for the connection to the value of the associated modified call stack (step 1114). In step 1114, a connection's associated modified call stack can be replaced. Step 1114 can perform replacement at this point of the process because the intolerable number of discards and changes to usage that were observed cause the statement pool to have a distribution of statements that is no longer a good match for the original modified stack from when the connection was first created. In this step, the connection's modified call stack is replaced with the modified call stack for the request associated with the most recent usage that it is now most consistent with. The process then proceeds to step 1116. With reference again to step 1108, if the discard counter is not less than or equal to the discard threshold, the process proceeds to step 1112 as described above.

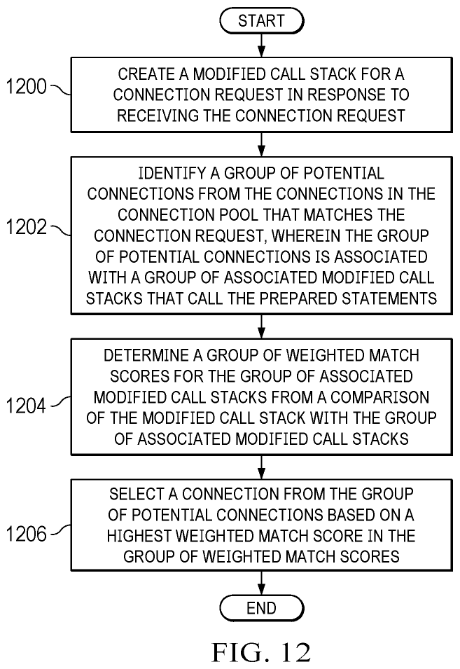

Turning next to FIG. 12, a flowchart of a process for managing connections in a connection pool is depicted in accordance with an illustrative embodiment. The process in FIG. 12 can be implemented in hardware, software, or both. When implemented in software, the process can take the form of program instructions that is run by one of more processor units located in one or more hardware devices in one or more computer systems. For example, the process can be implemented in connection manager 214 in computer system 212 in FIG. 2.

The process begins by creating a modified call stack for a connection request in response to receiving the connection request (step 1200). In step 1200, the modified call stack comprises elements that call prepared statements that are part of an application logic for the connection request.

The process identifies a group of potential connections from the connections in the connection pool that matches the connection request, wherein the group of potential connections is associated with a group of associated modified call stacks that call the prepared statements (step 1202). The process determines a group of weighted match scores for the group of associated modified call stacks from a comparison of the modified call stack with the group of associated modified call stacks (step 1204).

The process selects a connection from the group of potential connections based on a highest weighted match score in the group of weighted match scores (step 1206). The process terminates thereafter.

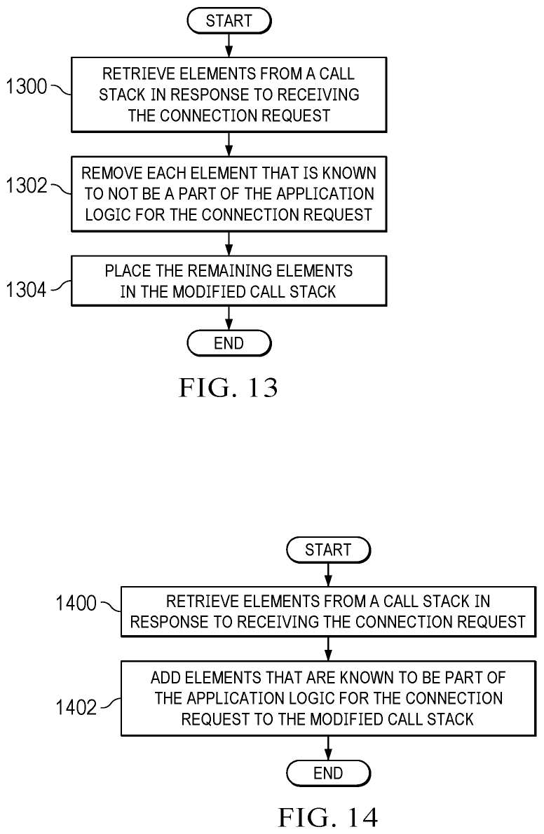

With reference to FIG. 13, a flowchart of a process for creating a modified call stack is depicted in accordance with an illustrative embodiment. The process in FIG. 13 is an example of one implementation for step 1200 in FIG. 12.

The process begins by retrieving elements from a call stack in response to receiving the connection request (step 1300). The process removes each element that is known to not be a part of the application logic for the connection request (step 1302).

The process places the remaining elements in the modified call stack (step 1304). The process terminates thereafter.

Next in FIG. 14, a flowchart of another process for creating a modified call stack is depicted in accordance with an illustrative embodiment. The process in FIG. 13 is another example of an implementation for step 1200 in FIG. 12.

The process begins by retrieving elements from a call stack in response to receiving the connection request (step 1400). The process adds elements that are known to be part of the application logic for the connection request to the modified call stack (step 1402). The process terminates thereafter.

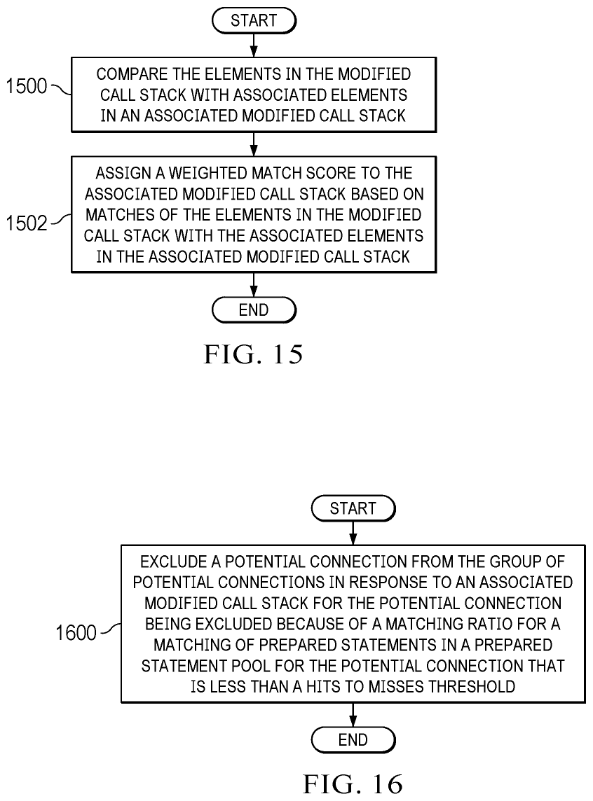

Turning now to FIG. 15, a flowchart of a process for determining a group of weighted match scores is depicted in accordance with an illustrative embodiment. The process illustrated in FIG. 15 is an example of an implementation for step 1204 in FIG. 12.

The process begins by comparing the elements in the modified call stack with associated elements in an associated modified call stack (step 1500). The process assigns a weighted match score to the associated modified call stack based on matches of the elements in the modified call stack with the associated elements in the associated modified call stack (step 1502). The process terminates thereafter.

In this example, the weighted match score is higher for a first match between more recent elements in the modified call stack and the associated elements in the associated modified call stack as compared to a second match between older elements in the modified call stack and the associated elements in the associated modified call stack. This process can be repeated to compare the modified call stack with each associated modified call stack to determine the group of weighted match scores.

With reference to FIG. 16, a flowchart of a process for excluding a potential connection is depicted in accordance with an illustrative embodiment. The process illustrated in FIG. 16 is an example of an additional step that can be performed in the process in FIG. 12.

The process excludes a potential connection from the group of potential connections in response to an associated modified call stack for the potential connection being excluded because of a matching ratio for a matching of prepared statements in a prepared statement pool for the potential connection that is less than a hits to misses threshold (step 1600). The process terminates thereafter.

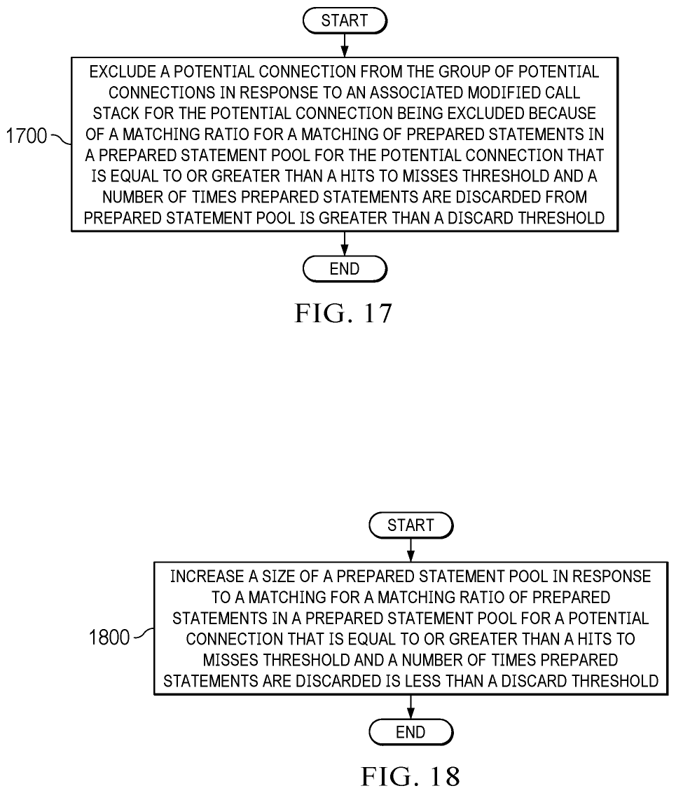

Next in FIG. 17, a flowchart of another process for excluding a potential connection is depicted in accordance with an illustrative embodiment. The process illustrated in FIG. 17 is an example of an additional step that can be performed in the process in FIG. 12.

The process excludes a potential connection from the group of potential connections in response to an associated modified call stack for the potential connection being excluded because of a matching ratio for a matching of prepared statements in a prepared statement pool for the potential connection that is equal to or greater than a hits to misses threshold and a number of times prepared statements are discarded from prepared statement pool is greater than a discard threshold (step 1700). The process terminates thereafter.

With reference to FIG. 18, a flowchart of another process for increasing a size of a prepared statement pool is depicted in accordance with an illustrative embodiment. The process illustrated in FIG. 18 is an example of an additional step that can be performed in the process in FIG. 12.

The process increases a size of a prepared statement pool in response to a matching for a matching ratio of prepared statements in a prepared statement pool for a potential connection that is equal to or greater than a hits to misses threshold and a number of times prepared statements are discarded is less than a discard threshold (step 1800). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

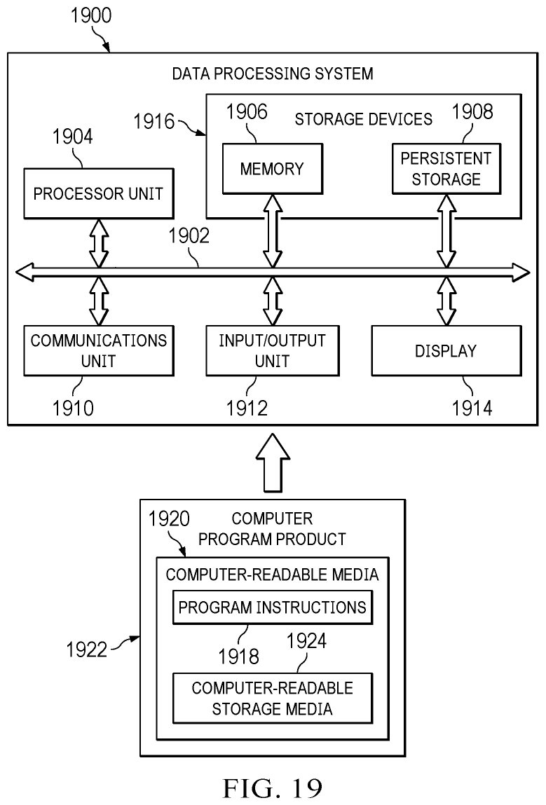

Turning now to FIG. 19, a block diagram of a data processing system is depicted in accordance with an illustrative embodiment. Data processing system 1900 can be used to implement computers and computing devices in computing environment 100 in FIG. 1. Data processing system 1900 can also be used to implement computer system 212. In this illustrative example, data processing system 1900 includes communications framework 1902, which provides communications between processor unit 1904, memory 1906, persistent storage 1908, communications unit 1910, input/output (I/O) unit 1912, and display 1914. In this example, communications framework 1902 takes the form of a bus system.

Processor unit 1904 serves to execute instructions for software that can be loaded into memory 1906. Processor unit 1904 includes one or more processors. For example, processor unit 1904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1904 can may be implemented using one or more heterogeneous processor systems in which a main processor is present with secondary processors on a single chip. As another illustrative example, processor unit 1904 can be a symmetric multi-processor system containing multiple processors of the same type on a single chip.

Memory 1906 and persistent storage 1908 are examples of storage devices 1916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1916 may also be referred to as computer-readable storage devices in these illustrative examples. Memory 1906, in these examples, can be, for example, a random-access memory or any other suitable volatile or non-volatile storage device. Persistent storage 1908 may take various forms, depending on the particular implementation.

For example, persistent storage 1908 may contain one or more components or devices. For example, persistent storage 1908 can be a hard drive, a solid-state drive (SSD), a flash memory, a rewritable optical disk, a rewritable magnetic tape, or some combination of the above. The media used by persistent storage 1908 also can be removable. For example, a removable hard drive can be used for persistent storage 1908.

Communications unit 1910, in these illustrative examples, provides for communications with other data processing systems or devices. In these illustrative examples, communications unit 1910 is a network interface card.

Input/output unit 1912 allows for input and output of data with other devices that can be connected to data processing system 1900. For example, input/output unit 1912 may provide a connection for user input through at least one of a keyboard, a mouse, or some other suitable input device. Further, input/output unit 1912 may send output to a printer. Display 1914 provides a mechanism to display information to a user.

Instructions for at least one of the operating system, applications, or programs can be located in storage devices 1916, which are in communication with processor unit 1904 through communications framework 1902. The processes of the different embodiments can be performed by processor unit 1904 using computer-implemented instructions, which may be located in a memory, such as memory 1906.

These instructions are referred to as program instructions, computer usable program instructions, or computer-readable program instructions that can be read and executed by a processor in processor unit 1904. The program instructions in the different embodiments can be embodied on different physical or computer-readable storage media, such as memory 1906 or persistent storage 1908.

Program instructions 1918 is located in a functional form on computer-readable media 1920 that is selectively removable and can be loaded onto or transferred to data processing system 1900 for execution by processor unit 1904. Program instructions 1918 and computer-readable media 1920 form computer program product 1922 in these illustrative examples. In the illustrative example, computer-readable media 1920 is computer-readable storage media 1924.

Computer readable storage media 1924 is a physical or tangible storage device used to store program instructions 1918 rather than a medium that propagates or transmits program instructions 1918. Computer readable storage media 1924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1918 can be transferred to data processing system 1900 using a computer readable signal media. The computer readable signal media are signals and can be, for example, a propagated data signal containing program instructions 1918. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1920” can be singular or plural. For example, program instructions 1918 can be located in computer-readable media 1920 in the form of a single storage device or system. In another example, program instructions 1918 can be located in computer-readable media 1920 that is distributed in multiple data processing systems. In other words, some instructions in program instructions 1918 can be located in one data processing system while other instructions in program instructions 1918 can be located in one data processing system. For example, a portion of program instructions 1918 can be located in computer-readable media 1920 in a server computer while another portion of program instructions 1918 can be located in computer-readable media 1920 located in a set of client computers.

The different components illustrated for data processing system 1900 are not meant to provide architectural limitations to the manner in which different embodiments can be implemented. In some illustrative examples, one or more of the components may be incorporated in or otherwise form a portion of, another component. For example, memory 1906, or portions thereof, may be incorporated in processor unit 1904 in some illustrative examples. The different illustrative embodiments can be implemented in a data processing system including components in addition to or in place of those illustrated for data processing system 1900. Other components shown in FIG. 19 can be varied from the illustrative examples shown. The different embodiments can be implemented using any hardware device or system capable of running program instructions 1918.

Thus, illustrative embodiments of the present invention provide a computer implemented method, computer system, and computer program product managing connections in a connection pool. A computer system creates a modified call stack for a connection request in response to receiving the connection request, wherein the modified call stack comprises elements that call prepared statements that are part of an application logic for the connection request. The computer system identifies a group of potential connections from the connections in the connection pool that matches the connection request. The group of potential connections is associated with a group of associated modified call stacks that call the prepared statements. The computer system determines a group of weighted match scores for the group of associated modified call stacks from a comparison of the modified call stack with the group of associated modified call stacks. The computer system selects a connection from the group of potential connections based on a highest weighted match score in the group of weighted match scores.

In one or more illustrative examples the maximum prepared statement pool size can be reduced through this type of connection management. In the illustrative example, each respective prepared statement pool associated with each pool connection only needs to retain a sufficient number of prepared statements to meet the use of pattern that pertains to a particular connection pool. Further, one or more illustrative examples can involve dynamically assigning or changing the maximum size of the statement pool. In this manner, user input and user analysis are unnecessary to reduce memory usage by prepared statements in prepared statement pools. Additionally, the management of connection pools associated with a prepared statement pools can be performed without making changes to an application or a need for user analysis to make adjustments to the prepared statement pool size.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing connections in a connection pool, the computer implemented method comprising:
creating, by a computer system, a modified call stack for a connection request in response to receiving the connection request, wherein the modified call stack comprises elements that call prepared statements that are part of an application logic for the connection request;
identifying, by the computer system, a group of potential connections from the connections in the connection pool that matches the connection request, wherein the group of potential connections is associated with a group of associated modified call stacks that call the prepared statements;
determining, by the computer system, a group of weighted match scores for the group of associated modified call stacks from a comparison of the modified call stack with the group of associated modified call stacks; and
selecting, by the computer system, a connection from the group of potential connections based on a highest weighted match score in the group of weighted match scores.

2. The computer implemented method of claim 1, wherein creating, by the computer system, the modified call stack for the connection request in response to receiving the connection request comprises:
retrieving, by the computer system, elements from a call stack in response to receiving the connection request;
removing, by the computer system, each element that is known to not be a part of the application logic for the connection request; and
placing, by the computer system, remaining elements in the modified call stack.

3. The computer implemented method of claim 1, wherein creating, by the computer system, the modified call stack for the connection request in response to receiving the connection request comprises:
retrieving, by the computer system, elements from a call stack in response to receiving the connection request; and
adding, by the computer system, elements that are known to be part of the application logic for the connection request to the modified call stack.

4. The computer implemented method of claim 1, wherein determining, by the computer system, the group of weighted match scores for the group of associated modified call stacks from the comparison of the modified call stack with the group of associated modified call stacks comprises:
comparing, by the computer system, the elements in the modified call stack with associated elements in an associated modified call stack; and
assigning, by the computer system, a weighted match score to the associated modified call stack based on matches of the elements in the modified call stack with the associated elements in the associated modified call stack.

5. The computer implemented method of claim 4, wherein the weighted match score is higher for a first match between more recent elements in the modified call stack and the associated elements in the associated modified call stack as compared to a second match between older elements in the modified call stack and the associated elements in the associated modified call stack.

6. The computer implemented method of claim 1 further comprising:
excluding, by the computer system, a potential connection from the group of potential connections in response to an associated modified call stack for the potential connection being excluded because of a matching ratio for a matching of prepared statements in a prepared statement pool for the potential connection that is less than a hits to misses threshold.

7. The computer implemented method of claim 1 further comprising:
excluding, by the computer system, a potential connection from the group of potential connections in response to an associated modified call stack for the potential connection being excluded because of a matching ratio for a matching of prepared statements in a prepared statement pool for the potential connection that is equal to or greater than a hits to misses threshold and a number of times prepared statements are discarded from prepared statement pool is greater than a discard threshold.

8. The computer implemented method of claim 1 further comprising:
increasing, by the computer system, a size of a prepared statement pool in response to a matching for a matching ratio of prepared statements in a prepared statement pool for a potential connection that is equal to or greater than a hits to misses threshold and a number of times prepared statements are discarded is less than a discard threshold.

9. A computer system comprising:
a number of processor units, wherein the number of processor units executes program instructions to:
create a modified call stack for a connection request in response to receiving the connection request, wherein the modified call stack comprises elements that call prepared statements that are part of an application logic for the connection request;
identify a group of potential connections from connections in a connection pool that matches the connection request, wherein the group of potential connections is associated with a group of associated modified call stacks that call the prepared statements;
determine a group of weighted match scores for the group of associated modified call stacks from a comparison of the modified call stack with the group of associated modified call stacks; and
select a connection from the group of potential connections based on a highest weighted match score in the group of weighted match scores.

10. The computer system of claim 9, wherein in creating the modified call stack for the connection request in response to receiving the connection request, the number of processor units executes the program instructions to:
retrieve elements from a call stack in response to receiving the connection request;
remove each element that is known to not be a part of the application logic for the connection request; and
place remaining elements in the modified call stack.

11. The computer system of claim 9, wherein in creating the modified call stack for the connection request in response to receiving the connection request, the number of processor units executes the program instructions to:
retrieve elements from a call stack in response to receiving the connection request; and
add elements that are known to be part of the application logic for the connection request to the modified call stack.

12. The computer system of claim 9, wherein in determining the group of weighted match scores for the group of associated modified call stacks from the comparison of the modified call stack with the group of associated modified call stacks, the number of processor units executes the program instructions to:
compare the elements in the modified call stack with associated elements in an associated modified call stack; and
assign a weighted match score to the associated modified call stack based on matches of the elements in the modified call stack with the associated elements in the associated modified call stack.

13. The computer system of claim 12, wherein the weighted match score is higher for a first match between more recent elements in the modified call stack and the associated elements in the associated modified call stack as compared to a second match between older elements in the modified call stack and the associated elements in the associated modified call stack.

14. The computer system of claim 9, wherein the number of processor units executes the program instructions to:
exclude a potential connection from the group of potential connections in response to an associated modified call stack for the potential connection being excluded because of a matching ratio for a matching of prepared statements in a prepared statement pool for the potential connection that is less than a hits to misses threshold.

15. The computer system of claim 9, wherein the number of processor units executes the program instructions to:
exclude a potential connection from the group of potential connections in response to an associated modified call stack for the potential connection being excluded because of a matching ratio for a matching of prepared statements in a prepared statement pool for the potential connection that is equal to or greater than a hits to misses threshold and a number of times prepared statements are discarded from prepared statement pool is greater than a discard threshold.

16. The computer system of claim 9, wherein the number of processor units executes the program instructions to:
increase a size of a prepared statement pool in response to a matching ratio for a matching of prepared statements in a prepared statement pool for a potential connection that is equal to or greater than a hits to misses threshold and a number of times prepared statements are discarded is less than a discard threshold.

17. A computer program product for managing connections in a connection pool, the computer program product comprising a computer readable storage medium having program instructions embodied therewith, the program instructions executable by a computer system to cause the computer system to perform a method of:
creating, by a computer system, a modified call stack for a connection request in response to receiving the connection request, wherein the modified call stack comprises elements that call prepared statements that are part of an application logic for the connection request;
identifying, by the computer system, a group of potential connections from the connections in the connection pool that matches the connection request, wherein the group of potential connections is associated with a group of associated modified call stacks that call the prepared statements;
determining, by the computer system, a group of weighted match scores for the group of associated modified call stacks from a comparison of the modified call stack with the group of associated modified call stacks; and
selecting, by the computer system, a connection from the group of potential connections based on a highest weighted match score in the group of weighted match scores.

18. The computer program product of claim 17, wherein creating the modified call stack for the connection request in response to receiving the connection request comprises:
retrieving, by the computer system, elements from a call stack in response to receiving the connection request;
removing, by the computer system, each element that is known to not be a part of the application logic for the connection request; and
placing, by the computer system, remaining elements in the modified call stack.

19. The computer program product of claim 17 wherein creating the modified call stack for the connection request in response to receiving the connection request comprises:
retrieving, by the computer system, elements from a call stack in response to receiving the connection request; and
adding, by the computer system, elements that are known to be part of the application logic for the connection request to the modified call stack.

20. The computer program product of claim 17, wherein determining the group of weighted match scores for the group of associated modified call stacks from the comparison of the modified call stack with the group of associated modified call stacks comprises:
comparing, by the computer system, the elements in the modified call stack with associated elements in an associated modified call stack; and
assigning, by the computer system, a weighted match score to the associated modified call stack based on matches of the elements in the modified call stack with the associated elements in the associated modified call stack.
